(19) United States
(12) Patent Application Publication
(10) Pub. No.: US 2025/0294030 A1
(43) Pub. Date: Sep. 18, 2025

(54) Managing Tenant Users in Coordination with Identity Provider

(71) Applicant: Rakuten Symphony, Inc., Tokyo (JP)

(72) Inventors: Thomas Jay Morano, Scotts Valley, CA (US); Tushar Anil Doshi, Santa Clara, CA (US)

(21) Appl. No.: 18/245,790

(22) PCT Filed: Dec. 9, 2022
(86) PCT No.: PCT/US2022/052400

§ 371 Date: Mar. 17, 2023

(51) Int. Cl. H04L 9/40

(52) U.S. Cl. CPC H04L 63/104

(57) ABSTRACT

Systems and methods for mapping users to tenants within a containerized workload management architecture. A method includes identifying a tenant group comprising a plurality of users. The method includes mapping the tenant group to a tenant and adding the tenant to a cluster, wherein the cluster comprises compute resources for executing workloads. The method is such that each of the plurality of users within the tenant group is assigned a same role and same permissions within the cluster.

### TECHNICAL FIELD

This disclosure relates generally to compute system configurations and specifically to assigning roles and permissions to users within a cloud-network architecture.

### SUMMARY

Systems and methods for mapping users to tenants within a containerized workload management architecture. A method includes identifying a tenant group comprising a plurality of users. The method includes mapping the tenant group to a tenant and adding the tenant to a cluster, wherein the cluster comprises compute resources for executing workloads. The method is such that each of the plurality of users within the tenant group is assigned the same role and same permissions within the cluster.

### BACKGROUND

Numerous industries benefit from and rely upon cloud-based computing resources to store data, access data, and run applications based on the stored data. In some cases, these industries require that distinct roles, permissions, and capabilities be assigned to different users. The assigned roles, permissions, and capabilities determine which users have read or write access to certain data, which users are capable of altering system configurations, which users are capable of altering workflows, and so forth. However, in traditional systems, it can be tedious to manually configure the role, permissions, and capabilities for each user within a cloud-based network architecture.

In view of the foregoing, disclosed herein are systems, methods, and devices for adjusting user configuration settings for a group of users within a cloud-based network architecture.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is a schematic block diagram of a system for automated deployment, scaling, and management of containerized workloads and services, wherein the system draws on storage distributed across shared storage resources;

FIG. 1B is a schematic block diagram of a system for automated deployment, scaling, and management of containerized workloads and services, wherein the system draws on storage within a stacked storage cluster;

FIG. 2 is a schematic block diagram of a system for automated deployment, scaling, and management of containerized applications;

FIG. 3 is a schematic block diagram illustrating a system for managing containerized workloads and services;

FIG. 4 is a schematic block diagram illustrating a system multi-team tenancy within a cluster, and for assigning permissions to users associated with the cluster;

FIG. 5 is a schematic block diagram of an example namespace configuration for a cluster;

FIG. 6 is a schematic block diagram of a system for mapping tenant groups to a tenant, and further for adding the tenant to a cluster;

FIG. 7 is a schematic block diagram illustrating a system for communicating with an identity provider to synchronize external users of an external tenant group with an identity provider user group;

FIG. 8 is a schematic block diagram illustrating a system for communications between an external tenant group and an identity provider, wherein the system executes a synchronization process flow for synchronizing the identity provider user group with a listing of external users associated with the external tenant group;

FIG. 9 is a schematic block diagram of a system comprising a plurality of clusters that are each managed by users associated with an identity provider;

FIG. 10 is a schematic flow chart diagram of a method for mapping a tenant group to a tenant within a cluster; and

FIG. 11 is a schematic block diagram of an example computing device suitable for implementing methods in accordance with embodiments of the invention.

### DETAILED DESCRIPTION

Disclosed herein are systems, methods, and devices for managing groups of tenant users together as a single unit within a cloud-based network architecture. Specifically disclosed herein are means to map a group of users to a tenant within a cluster, and then set the same tenant roles, user capabilities, and permissions for each of the users within the group. Further disclosed herein are means for synchronizing a tenant user group with an external user group associated with an identity provider (IDP).

In a containerized workload management system as described herein, a system administrator may create a tenant to organize users associated with a cluster. The users may be split into discrete groups based on function or business requirements. A single user may be a member of multiple tenants but is only allowed to access resources bound to the tenant they are currently logged into. Each tenant user is assigned a role, capabilities, and permission that determine what types of objects the user can access and which operations the user may perform when logged into the tenant.

In traditional systems, it can be exceedingly tedious to manually add all users one-by-one to every appropriate cluster. In these traditional systems, it is not possible to manage groups of tenant users together as a single unit in a cluster. Additionally, users managed by an external IDP must be manually added one cluster at a time. This takes a significant amount of time and resources to complete.

In view of the deficiencies in traditional systems, disclosed herein are systems, methods, and devices for creating a tenant group and then assigning all users within the tenant group the same role, capabilities, and permissions. Further described herein are means for creating an external tenant group that synchronizes with an IDP user group, wherein the IDP user group is managed by an external entity.

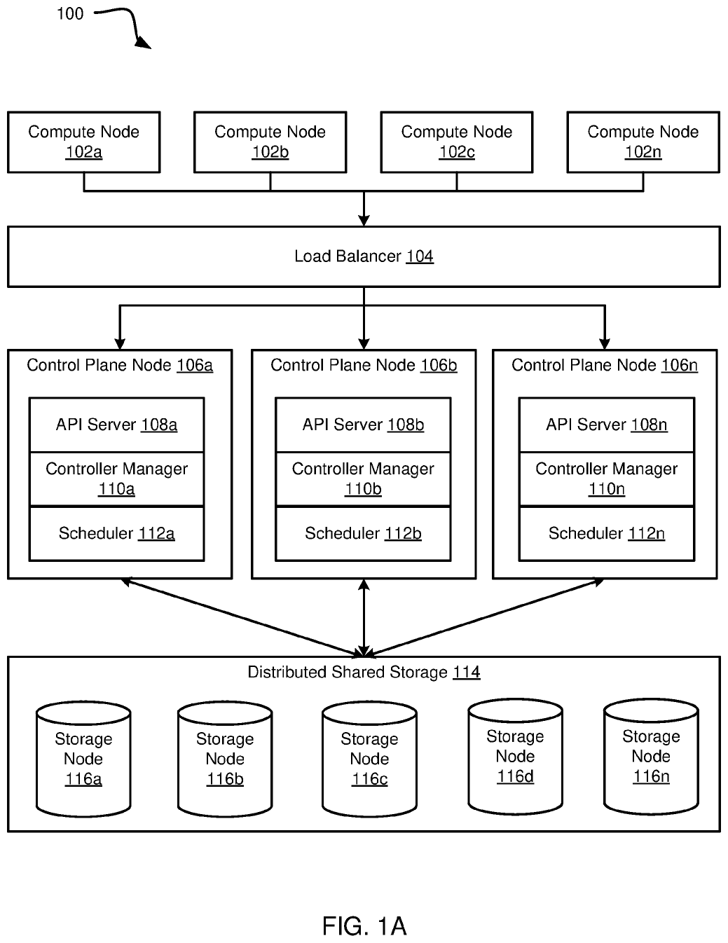

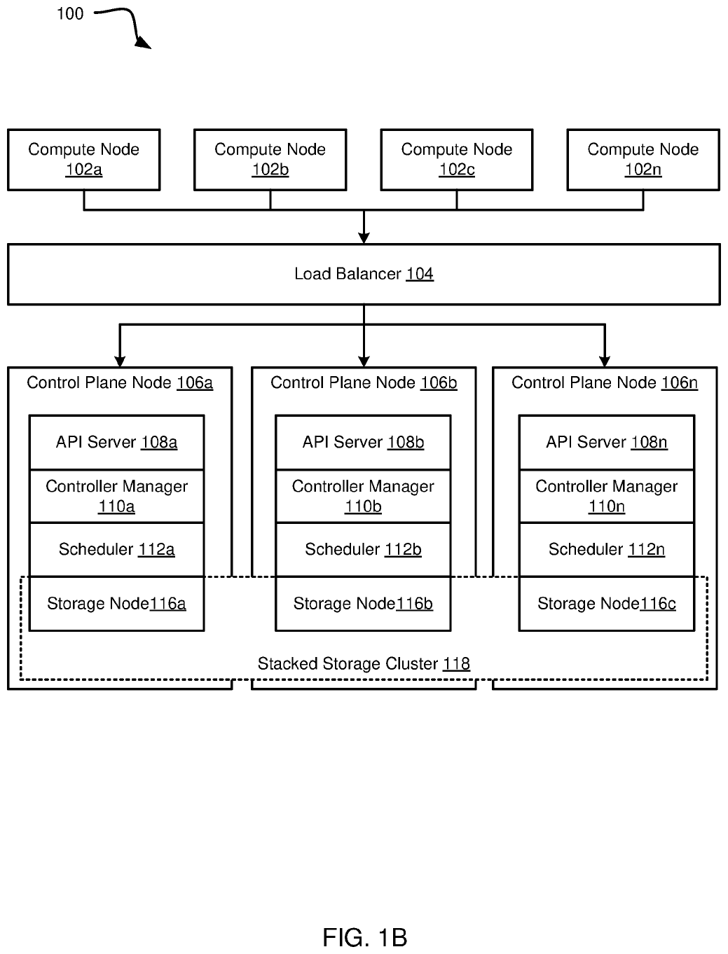

Referring now to the figures, FIGS. 1A and 1B are schematic illustrations of an example system 100 for automated deployment, scaling, and management of containerized workloads and services. The system 100 facilitates declarative configuration and automation through a distributed platform that orchestrates different compute nodes that may be controlled by central master nodes. The system 100 may include “n” number of compute nodes that can be distributed to handle pods.

The system 100 includes a plurality of compute nodes 102a, 102b, 102c, 102n (may collectively be referred to as compute nodes 102 as discussed herein) that are managed by a load balancer 104. The load balancer 104 assigns processing resources from the compute nodes 102 to one or more of the control plane nodes 106a, 106b, 106n (may collectively be referred to as control plane nodes 106 as discussed herein) based on need. In the example implementation illustrated in FIG. 1A, the control plane nodes 106 draw upon a distributed shared storage 114 resource comprising a plurality of storage nodes 116a, 116b 116c, 116d, 116n (may collectively be referred to as storage nodes 116 as discussed herein). In the example implementation illustrated in FIG. 1B, the control plane nodes 106 draw upon assigned storage nodes 116 within a stacked storage cluster 118.

The control planes 106 make global decisions about each cluster and detect and responds to cluster events, such as initiating a pod when a deployment replica field is unsatisfied. The control plane node 106 components may be run on any machine within a cluster. Each of the control plane nodes 106 includes an API server 108, a controller manager 110, and a scheduler 112.

The API server 108 functions as the front end of the control plane node 106 and exposes an Application Program Interface (API) to access the control plane node 106 and the compute and storage resources managed by the control plane node 106. The API server 108 communicates with the storage nodes 116 spread across different clusters. The API server 108 may be configured to scale horizontally, such that it scales by deploying additional instances. Multiple instances of the API server 108 may be run to balance traffic between those instances.

The controller manager 110 embeds core control loops associated with the system 100. The controller manager 110 watches the shared state of a cluster through the API server 108 and makes changes attempting to move the current state of the cluster toward a desired state. The controller manager 110 may manage one or more of a replication controller, endpoint controller, namespace controller, or service accounts controller.

The scheduler 112 watches for newly created pods without an assigned node, and then selects a node for those pods to run on. The scheduler 112 accounts for individual and collective resource requirements, hardware constraints, software constraints, policy constraints, affinity specifications, anti-affinity specifications, data locality, inter-workload interference, and deadlines.

The storage nodes 116 function as a distributed storage resources with backend service discovery and database. The storage nodes 116 may be distributed across different physical or virtual machines. The storage nodes 116 monitor changes in clusters and store state and configuration data that may be accessed by a control plane node 106 or a cluster. The storage nodes 116 allow the system 100 to support discovery service so that deployed applications can declare their availability for inclusion in service.

In some implementations, the storage nodes 116 are organized according to a key-value store configuration, although the system 100 is not limited to this configuration. The storage nodes 116 may create a database page for each record such that the database pages do not hamper other records while updating one. The storage nodes 116 may collectively maintain two or more copies of data stored across all clusters on distributed machines.

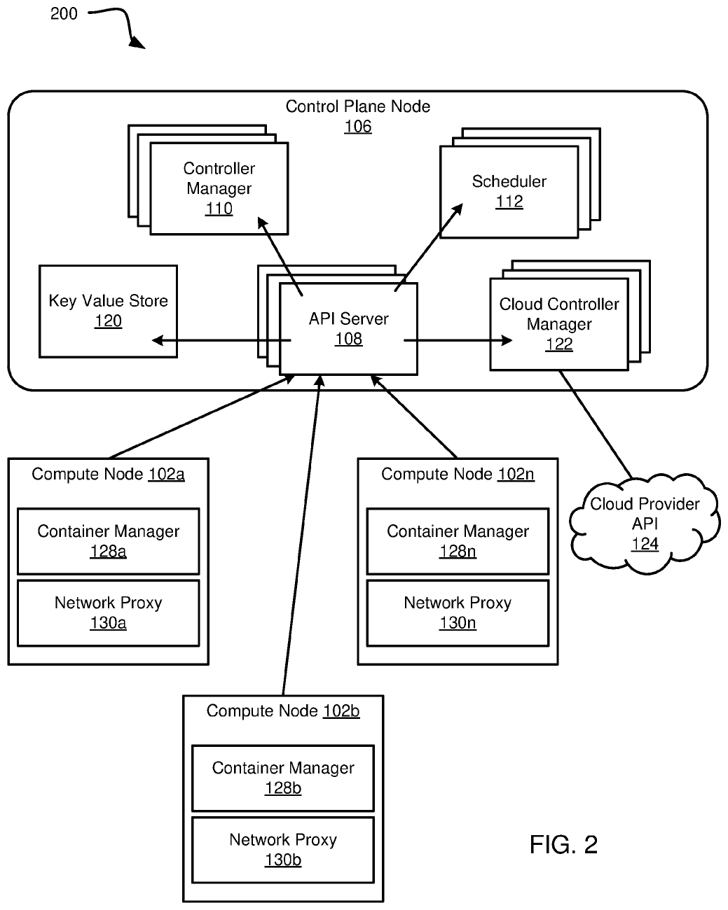

FIG. 2 is a schematic illustration of a cluster 200 for automating deployment, scaling, and management of containerized applications. The cluster 200 illustrated in FIG. 2 is implemented within the systems 100 illustrated in FIGS. 1A-1B, such that the control plane node 106 communicates with compute nodes 102 and storage nodes 116 as shown in FIGS. 1A-1B. The cluster 200 groups containers that make up an application into logical units for management and discovery.

The cluster 200 deploys a cluster of worker machines, identified as compute nodes 102a, 102b, 102n. The compute nodes 102a-102n run containerized applications, and each cluster has at least one node. The compute nodes 102a-102n host pods that are components of an application workload. The compute nodes 102a-102n may be implemented as virtual or physical machines, depending on the cluster. The cluster 200 includes a control plane node 106 that manages compute nodes 102a-102n and pods within a cluster. In a production environment, the control plane node 106 typically manages multiple computers and a cluster runs multiple nodes. This provides fault tolerance and high availability.

The key value store 120 is a consistent and available key value store used as a backing store for cluster data. The controller manager 110 manages and runs controller processes. Logically, each controller is a separate process, but to reduce complexity in the cluster 200, all controller processes are compiled into a single binary and run in a single process. The controller manager 110 may include one or more of a node controller, job controller, endpoint slice controller, or service account controller.

The cloud controller manager 122 embeds cloud-specific control logic. The cloud controller manager 122 enables clustering into a cloud provider API 124 and separates components that interact with the cloud platform from components that only interact with the cluster. The cloud controller manager 122 may combine several logically independent control loops into a single binary that runs as a single process. The cloud controller manager 122 may be scaled horizontally to improve performance or help tolerate failures.

The control plane node 106 manages any number of compute nodes 126. In the example implementation illustrated in FIG. 2, the control plane node 106 is managing three nodes, including a first node 126a, a second node 126b, and an nth node 126n (which may collectively be referred to as compute nodes 126 as discussed herein). The compute nodes 126 each include a container manager 128 and a network proxy 130.

The container manager 128 is an agent that runs on each compute node 126 within the cluster managed by the control plane node 106. The container manager 128 ensures that containers are running in a pod. The container manager 128 may take a set of specifications for the pod that are provided through various mechanisms, and then ensure those specifications are running and healthy.

The network proxy 130 runs on each compute node 126 within the cluster managed by the control plane node 106. The network proxy 130 maintains network rules on the compute nodes 126 and allows network communication to the pods from network sessions inside or outside the cluster.

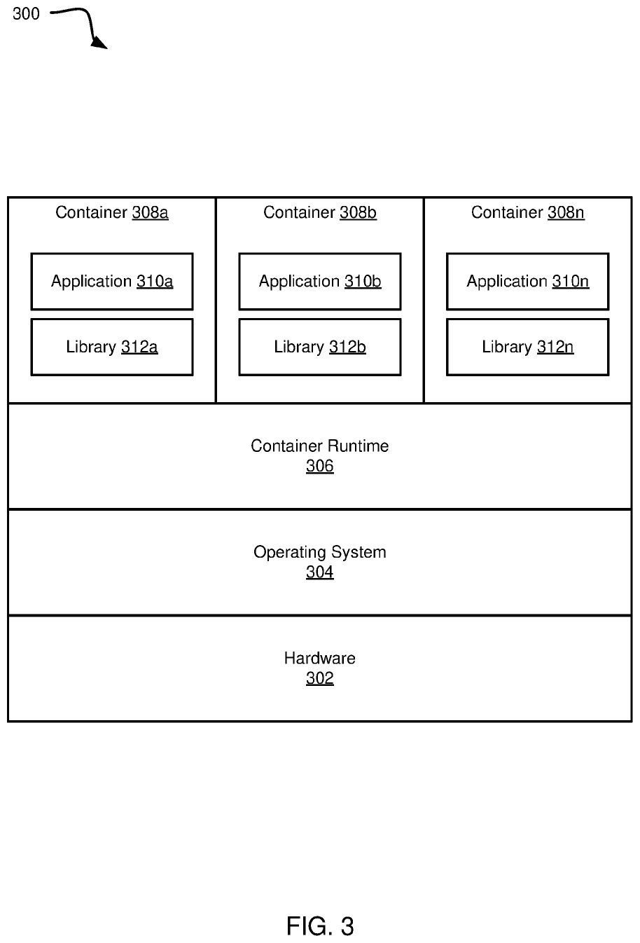

FIG. 3 is a schematic diagram illustrating a system 300 for managing containerized workloads and services. The system 300 includes hardware 302 that supports an operating system 304 and further includes a container runtime 306, which refers to the software responsible for running containers 308. The hardware 302 provides processing and storage resources for a plurality of containers 308a, 308b, 308n that each run an application 310 based on a library 312. The system 300 discussed in connection with FIG. 3 is implemented within the systems 100, 200 described in connection with FIGS. 1A-1B and 2.

The containers 308 function similar to a virtual machine but have relaxed isolation properties and share an operating system 304 across multiple applications 310. Therefore, the containers 308 are considered lightweight. Similar to a virtual machine, a container has its own file systems, share of CPU, memory, process space, and so forth. The containers 308 are decoupled from the underlying instruction and are portable across clouds and operating system distributions.

Containers 308 are repeatable and may decouple applications from underlying host infrastructure. This makes deployment easier in different cloud or OS environments. A container image is a ready-to-run software package, containing everything needed to run an application, including the code and any runtime it requires, application and system libraries, and default values for essential settings. By design, a container 308 is immutable such that the code of a container 308 cannot be changed after the container 308 begins running.

The containers 308 enable certain benefits within the system. Specifically, the containers 308 enable agile application creation and deployment with increased ease and efficiency of container image creation when compared to virtual machine image use. Additionally, the containers 308 enable continuous development, integration, and deployment by providing for reliable and frequent container image build and deployment with efficient rollbacks due to image immutability. The containers 308 enable separation of development and operations by creating an application container at release time rather than deployment time, thereby decoupling applications from infrastructure. The containers 308 increase observability at the operating system-level, and also regarding application health and other signals. The containers 308 enable environmental consistency across development, testing, and production, such that the applications 310 run the same on a laptop as they do in the cloud. Additionally, the containers 308 enable improved resource isolation with predictable application 310 performance. The containers 308 further enable improved resource utilization with high efficiency and density.

The containers 308 enable application-centric management and raise the level of abstraction from running an operating system 304 on virtual hardware to running an application 310 on an operating system 304 using logical resources. The containers 304 are loosely coupled, distributed, elastic, liberated micro-services. Thus, the applications 310 are broken into smaller, independent pieces and can be deployed and managed dynamically, rather than a monolithic stack running on a single-purpose machine.

The containers 308 may include any container technology known in the art such as DOCKER, LXC, LCS, KVM, or the like. In a particular application bundle 406, there may be containers 308 of multiple distinct types in order to take advantage of a particular container's capabilities to execute a particular role 416. For example, one role 416 of an application bundle 406 may execute a DOCKER container 308 and another role 416 of the same application bundle 406 may execute an LCS container 308.

The system 300 allows users to bundle and run applications 310. In a production environment, users may manage containers 308 and run the applications to ensure there is no downtime. For example, if a singular container 308 goes down, another container 308 will start. This is managed by the control plane nodes 106, which oversee scaling and failover for the applications 310.

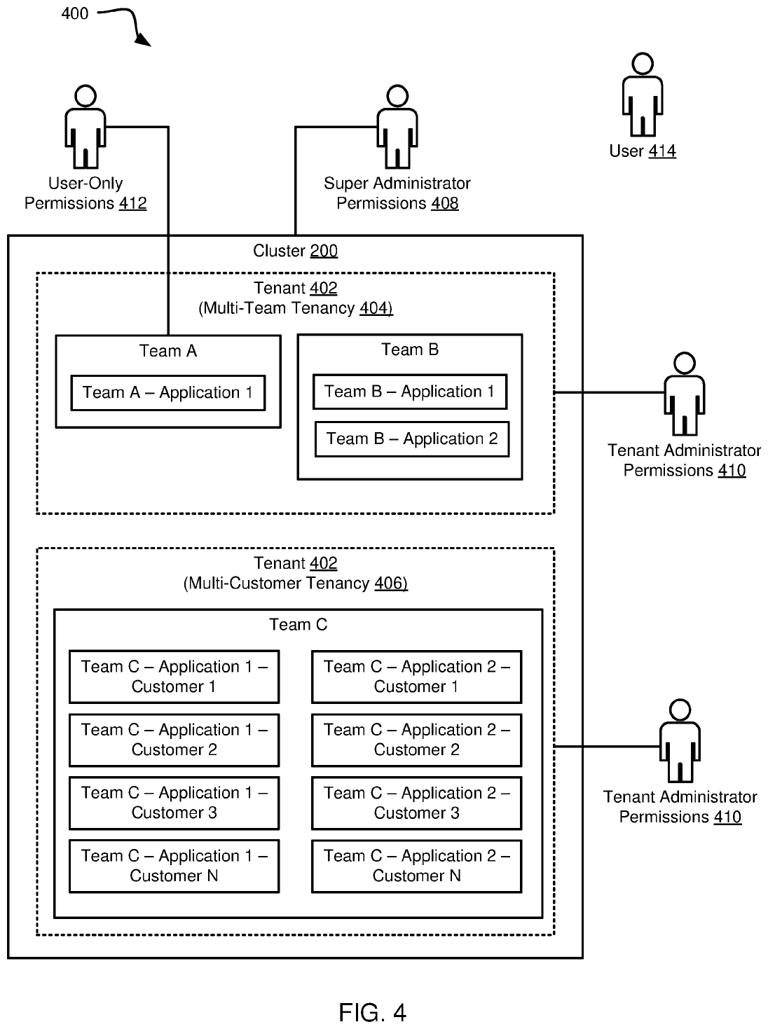

FIG. 4 is a schematic block diagram of an example tenancy scheme 400 with coexisting tenancy models within a single cluster 200. Tenants 402 are a system construct that enable users 414 to be organized into described groups based on function or business requirements. A user 414 may be a member of multiple tenants 402, but each user 414 is only able to access resources that are bound to the tenant they are currently logged into (i.e., a user 414 would not be able to access an application they deployed in one tenant when they were logged into a different tenant). In the systems described herein, a tenant includes one or more of a team responsible for developing and operating one or more workloads, a set of related workloads (whether operated by one or more teams), or a single workload such as a deployment. Cluster multi-tenancy as shown in FIG. 4 is often implemented to reduce costs or to consistently apply administration policies across tenants 402.

Each person accessing the cluster 200 does so with a unique account. The user account includes a username and identifier that uniquely identifies the user 414 within the cluster 200. All objects created by the user (including, e.g., applications) will be tagged with the user's identifier. The user account includes key attributes about the user 414, such as first and last name, email address, phone number, and so forth, and provides a means for authenticating the user 414 when they log into the cluster 200.

Each user 414 that logs into the cluster 200 has a set of permission mappings that determine which operations they can perform on which object types. The set of permission mappings is determined by which user capabilities have been assigned to the user 414 for the tenant 402 they are currently logged into. A user's 414 current permissions are the set of all permission mappings assigned to the user 414 based on their assigned user capabilities plus those from inherited capabilities. Users 414 may be mapped to multiple tenants 402, and users 414s who are assigned to multiple tenants 402 can have a different role and permissions for each tenant 402 they are a member of. In an example system, users 414 may be granted super administrator permissions 408, tenant administrator permissions 410, and/or user-only permissions 412.

Users 414 having super administrator permissions 408 have full access to all cluster 200 objects and resources, including those bound to individual tenants 402. Users 414 with super administrator permissions 408 are able to perform all administrative functions within the cluster 200, such as adding users 414 to the cluster 200, registering and sharing storage repositories, exporting/importing application backups, and so forth.

Users 414 with tenant administrator permissions 410 have many of the same permissions as users with super administrator permissions 408, but their scope is limited to a particular tenant 402 within the cluster 200. A user 414 with tenant administrator permissions 410 is able to view resources bound to their respective tenant 402, can register and share storage repositories, export/import application backups, and so forth.

Users 414 assigned user-only permissions 412 have no cluster 200 or tenant 402 administrative capabilities and are generally limited to managing applications they have deployed or registered. Additionally, a system administrator may grant custom user capabilities the enable those with user-only permissions 412 to perform limited administrative tasks.

The example cluster 200 depicted in FIG. 4 is shared by multiple tenants 402. This configuration reduces costs and simplifies administration of the system. However, cluster sharing amongst tenants 402 presents challenges such as security, fairness, and managing co-tenant members that monopolize bandwidth, disk input/output, compute resources, and so forth. Clusters 200 may be shared in numerous ways. In some cases, different applications are executed by the same cluster 200 as shown in FIG. 4, wherein the cluster 200 is running each of Application 1 and Application 2. Additionally, a single cluster 200 may execute multiple instances of the same application, with one application instance for each customer. This is depicted in FIG. 4, wherein the cluster 200 is running Application 1 for each of Customer 1, Customer 2, Customer 3, and up through Customer N.

The example tenancy scheme 400 illustrated in FIG. 4 implements multi-team tenancy 404 and multi-customer tenancy 406. Multi-team tenancy 404 is commonly employed when sharing a cluster 200 between multiple teams within an organization. In multi-team tenancy 404, a tenant 402 is typically a team, where each team typically deploys a small number of workloads that scales with the complexity of the service. Multi-team tenancy 404 enables each team within the organization to operate one or more workloads executed by the cluster 200. These workloads frequently need to communicate with each other and with other workloads located on the same or different clusters. In this scenario, members of the teams often have direct access to system resources or indirect access through GitOps controllers or other types of release automation tools.

Multi-customer tenancy 406 is commonly employed when deploying a Software-as-a-Service (SaaS). In multi-customer tenancy 406, a tenant member typically includes one or more customers who share a single workload. Each “customer” may be as large as an entire company or as small as a single team within that company. In multi-customer tenancy 406, the cluster 200 runs multiple instances of a workload to accommodate multiple customers. In this scenario, users 414 do not have access to the cluster 200. Cost optimization is frequently a critical concern, and the cluster 200 may be configured to ensure that workloads for the various customers are strongly isolated from each other.

In many cases, the same organization may use both types of tenants 402 in different contexts. For example, a platform team may offer shared services such as security tools and databases to multiple internal customers and a SaaS vendor may also have multiple teams sharing a development cluster. In an example implementation, a SaaS provider uses a combination of per-customer workloads for sensitive data, combined with multi-tenant shared services.

The control plane node 106 of the cluster 200 may apply the tenancy configurations as an organization requirement. The control plane node 106 may implement various isolations levels, including “hard” multi-tenancy with strong isolation or “soft” multi-tenancy with weaker isolation. Hard multi-tenancy is typically implemented when tenant members do not trust each other from security and resource sharing perspectives. In some cases, it may be necessary to forgo multi-tenancy cluster sharing and assign each tenant 402 a dedicated cluster, possibly even running on dedicated hardware if virtual machines are not considered an adequate security boundary.

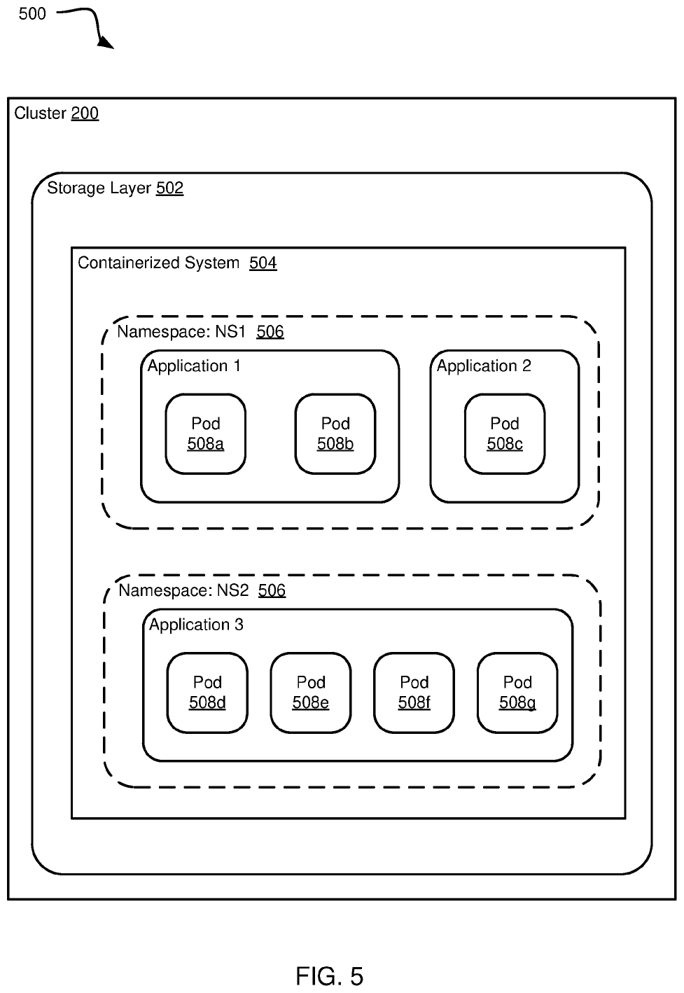

FIG. 5 is a schematic block diagram of an example namespace configuration 500 for a cluster 200. The namespace configuration 500 illustrated in FIG. 5 may be implemented with the multi-tenant configuration discussed in connection with FIG. 4. The namespaces described herein enable a cluster 200 to be partitioned into multiple “virtual clusters.” Names for resources deployed in a namespace 506 must be unique, but that restriction does not apply across namespaces 506. In addition to isolating application resources, namespaces 506 also provide a way to isolate groups of customers (i.e., users 414 within a tenant 402) and apportion cluster resources to those groups.

The example cluster 200 illustrated in FIG. 5 includes a storage layer 502 and a containerized system 504 operating in connection with the storage layer 502. The containerized system 504 may include the components discussed in connection with FIGS. 1-3 for executing containerized workloads. The example containerized system 504 depicted in FIG. 5 includes two different namespaces 506, including a first namespace NS1 and a second namespace NS2. The namespaces 506 provide a mechanism for isolating groups of API resources within a single cluster 200. Many system-wide security policies are scoped to namespaces 506. In a multi-tenant environment such as the tenancy scheme 400 illustrated in FIG. 4, a namespace 506 helps segment a tenant's workload into a logical and distinct management unit. In some cases, system administrators will isolate each workload to its own namespace 506, even if multiple workloads are operated by the same tenant 402. This ensures that each workload has its own identity and can be configured with an appropriate security policy.

In the example illustrated in FIG. 5, there are two applications mapped to the first namespace NS1, including Application 1 and Application 2. Application 1 is executed by two pods, including pod 508a and pod 508b. Application 2 is executed by a single pod 508c. The second namespace NS2 is dedicated to a single application, namely Application 3. Application 3 is executed by numerous pods, including pod 508d-508g.

The control plane node 106 of the cluster 200 implements role-based access control (RBAC) to enforce authorization for both customers and workloads. In a multi-team tenancy 404, the control plane node 106 implements RBAC to restrict tenant members' access to appropriate namespaces 506 and ensure that cluster-wide 200 resources can only be accessed or modified by privileged users 414 such as those with super administrator permissions 408. If a policy grants a user 414 more permissions than the user 414 needs, this typically signals that the namespace 506 containing the affected resources should be refactored into finger-grained namespaces 506.

The tenants 402 are isolated within the data plane (see storage layer 502) to ensure that pods 508 and workloads for different tenants 402 are sufficiently isolated. By default, all pods within a cluster 200 are allowed to communicate with one another and all network traffic is unencrypted. This can lead to security vulnerabilities where traffic is accidentally or maliciously sent to an unintended destination or is intercepted by a workload on a compromised node. Pod-to-pod communication can be controlled using network policies that restrict communication between pods 508 using namespace labels or IP address ranges. In a multi-tenant environment such as the one illustrated in FIG. 4, where strict network isolation between tenants 402 is required, it may be beneficial to implement a default policy that denies communication between pods 508. With this strict default policy in place, a system administrator may add more permissive rules that allow for communication within a single namespace 506.

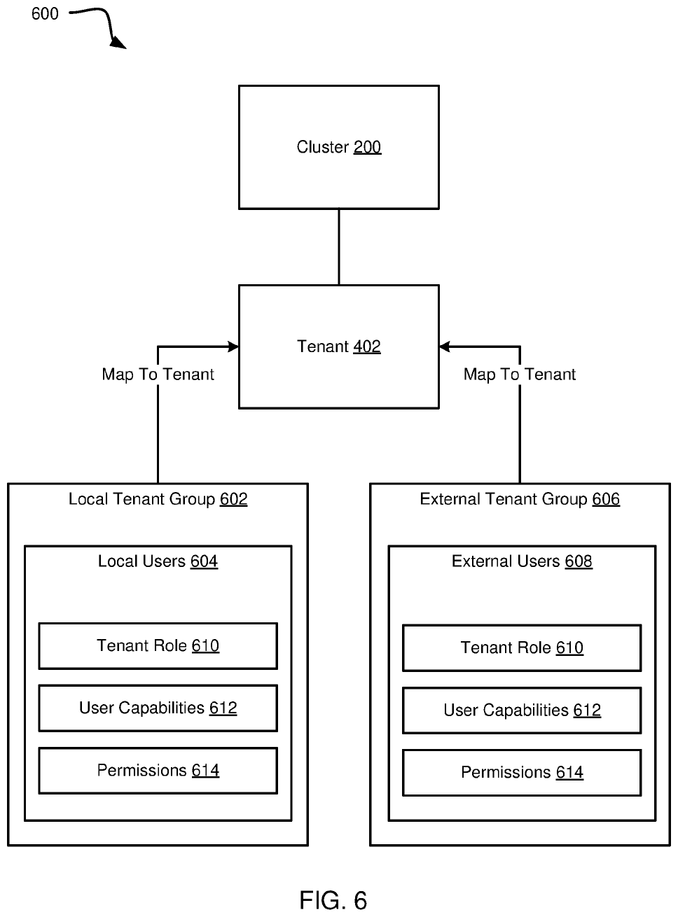

FIGS. 6-9 illustrate systems and process flows for mapping a tenant group to a tenant, wherein the tenant group includes a plurality of users each having the same role, capabilities, and permissions. The tenant groups discussed herein streamline the management of cluster users 414 and their membership in tenants 402. This is especially useful when there are multiple clusters 200 that require onboarding the same groups of users having the same role and access capabilities. The users can be managed as a group in an IDP user group and then mapped to various tenants in the cluster or in multiple clusters.

FIG. 6 is a schematic block diagram of a system 600 for mapping tenant groups to a tenant. In traditional systems, it is not possible to manage groups of tenant users together as a single unit within a cluster 200. Instead, in these traditional systems, the roles, capabilities, and permissions for tenant users must be assigned individually. The system 600 addresses these inefficiencies and enables groupings of tenant users to be mapped to the tenant 402 with identical specifications.

In the example system 600 illustrated in FIG. 6, there are two distinct tenant groups mapped to the tenant 402, including a local tenant group 602 and an external tenant group 612. The local tenant group 602 manages a listing of local users 604 associated with the local tenant group 602. Each of the local users 604 is assigned the same tenant role 610, user capabilities 612, and permissions 614. The external tenant group 606 manages a listing of external users 608 associated with the external tenant group 606. Each of the external users 608 is assigned the same tenant role 610, user capabilities 612, and permission 614.

The local tenant group 602 includes local users, which are managed locally by the cluster 200 itself or the system the cluster 200 is apart of. The external tenant group 606 includes users belonging to an external identity provider (IDP). A single tenant group 602, 606 cannot include a mixture of local users 604 and external users 608. If a mixture of local users 604 and external users 608 are mapped to the same tenant 402, then the users must be split into separate tenant groups 602, 606 as shown in FIG. 6.

The tenant groups 602, 604 provide a mechanism for managing groups of users as a single unit. All users within the tenant group 602, 604 are assigned the same tenant role 610, user capabilities 612, and permissions 614. Any changes in the roles 610, capabilities 612, or permissions 614 for the tenant group 602, 604 are applied to all users within the tenant group. When a new user is added to the tenant group 602, 604, that user is automatically added to the mapped tenant 402. Conversely, when a user is removed from a tenant group 602, 604, that user is automatically removed from the mapped tenant 402.

A user 414 may be a member of multiple tenant groups 602, 604 within a cluster 200 (and by extension, multiple tenants 402). However, users 414 cannot be a member of multiple tenant groups 602, 604 mapped to the same tenant 402.

A single tenant group 602, 604 can only be mapped to a single tenant 402. However, multiple tenant groups 602, 604 with the same tenant role may be mapped to the same tenant 402. This allows groups of users with the same tenant role 610 to have different capabilities and permissions for the mapped tenant 402.

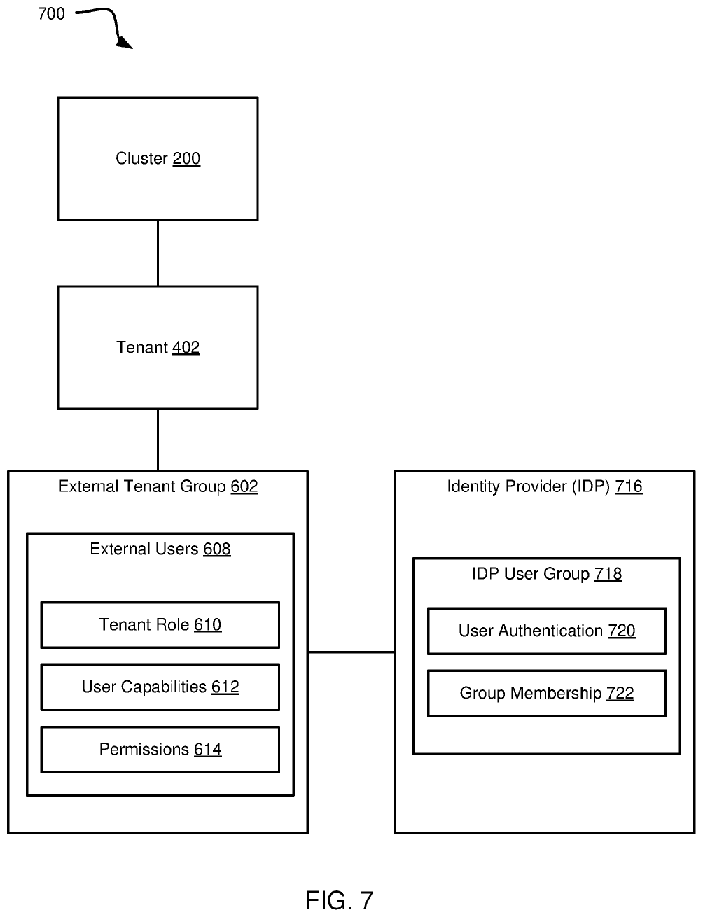

FIG. 7 is a schematic block diagram illustrating a system 700 for communicating with an identity provider (IDP) 716 to synchronize the external users 608 of the external tenant group 602 with an IDP user group 718. The IDP 716 manages user authentication 720 and group membership 722 for the IDP user group 718. The cluster 200 is not a managed part of the IDP 716 domain.

The IDP 716 is a system entity that creates, maintains, and manages identity information for principals. The IDP 716 provides authentication services to applications within a distributed network. The IDP 716 offers user authentication as a service, and relying party application, such as web application, outsource the user authentication step to the IDP 716. The IDP 716 may include an application protocol for accessing and maintaining distributed direction information services, such as the Lightweight Director Access Protocol (LDAP).

The IDP user group 718 can map to one or more tenant groups within a single cluster 200 and may further map to different tenant groups across different clusters 200. The IDP user group 718 cannot, however, map to multiple groups associated with the same tenant 402. Each external tenant group 602 a single IDP user group 718 maps to may be configured with a different tenant role 610, user capabilities 612, and permissions 614.

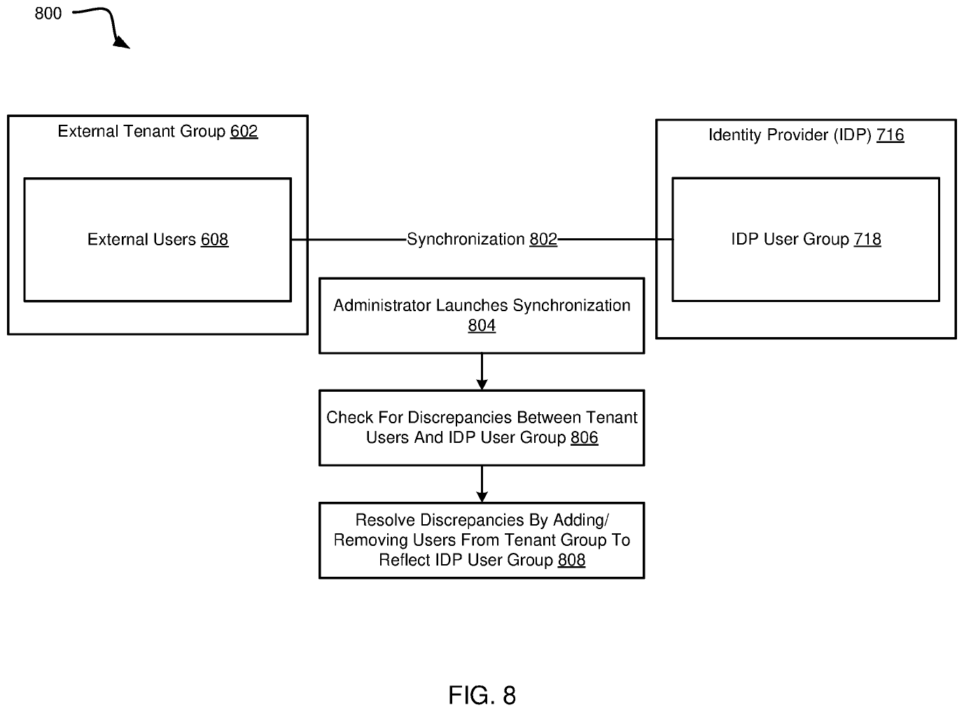

FIG. 8 is a schematic block diagram illustrating a system 800 for communications between an external tenant group 602 and an IDP 716. The system 800 executes a synchronization 802 process flow for synchronizing the IDP user group 718 with the listing of external users 608 associated with the external tenant group 602.

The IDP 716 may add or remove users from the IDP user group 718. However, this does not result in those users automatically being added or removed from mapped external tenant groups 602 within the cluster 200. This only occurs when the external tenant group 602 is synchronized 802 with the IDP user group 718.

The synchronization 802 process begins with an administrator launching at 804 the synchronization process. A user 414 with super administrator permissions 408 or tenant administrator permissions 410 may manually launch synchronization at any time. Additionally, the synchronization 802 process may be scheduled to execute on a periodic basis as a scheduled task.

The synchronization 802 process continues and the cluster 200 checks at 806 for discrepancies between the tenant external users 608 and the IDP user group 718. The cluster 200 determines whether there are any users 414 listed within the IDP user group 718 that are not on the list of external users 608. The cluster 200 additionally determines whether there are any users 414 on the list of external users 608 that are not listed within the IDP user group 718.

The synchronization 802 process continues and the cluster 200 resolves at 808 discrepancies by adding or removing users 414 from the tenant external users 608 to reflect the IDP user group 718. If users 414 have been added to the IDP user group 718 since the last synchronization 802, then those users are added to the listing of external users 608. If users 414 have been removed from the IDP user group 718 since the last synchronization 802, then those users are removed from the listing of external users 608.

Multiple external tenant groups 602 across multiple different clusters 200 may each map to the same IDP user group 718. However, each cluster 200 is only aware of its own external tenant group 602 mappings.

When adding external tenant groups 602 to a tenant group (because they were added to the mapped IDP user group 718), the users are not just added to the listing of users. The users are added as tenant users and are assigned a default namespace. Conversely, when a user is removed from an externally mapped IDP user group 718, the users are actually removed from the tenant. Ownership of any objects owned by the soon-to-be-removed user must be reassigned prior to the user being removed. When adding an external user, if the user does not already have an account within the cluster, a new account must be created for the user. Conversely, when removing a user from a tenant, the user's account must be removed from the cluster if the user is being removed from the last tenant they are a member of.

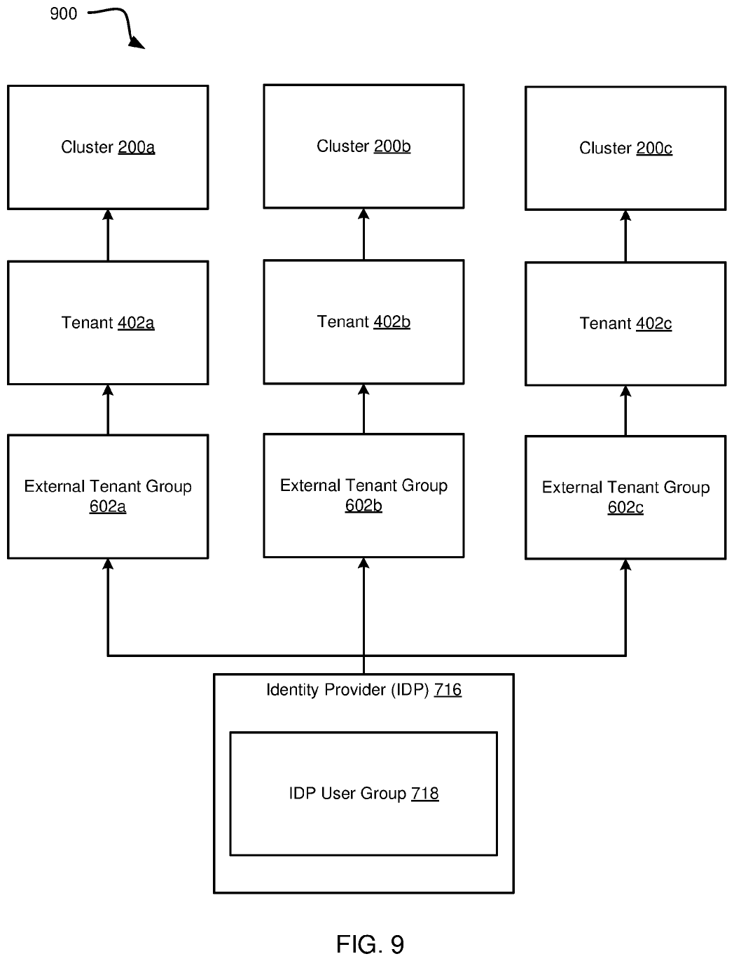

FIG. 9 is a schematic block diagram of a system 900 comprising a plurality of clusters 200a-200c that are each managed by users associated with an IDP 716. In the example system 900 illustrated in FIG. 9, the same IDP user group 718 maps to a plurality of different external tenant groups 602a, 602b, 602c. Each of the external tenant groups 602a-602c maps to a different tenant 402a-402c within a different cluster 200a-200c.

A single IDP user group 718 may be referenced by any number of external tenant groups 602a-602c across any number of clusters 200a-200c as needed. Each external tenant group 602a-602c is sequestered from the other external tenant groups 602a-602c, such that users associated with the external tenant groups 602a-602c cannot see that the same IDP user group 718 is mapped to other external tenant groups 602a-602c.

Additionally, a single external tenant group 602 may map to multiple tenants 402 and clusters 200, and this is not limited to administrative purposes. An external tenant group 602 may define a group of users with super administrator permissions 408, tenant administrator permissions 410, or user-only permissions 412. Multiple external tenant groups 402 may be mapped to the same tenant to provide increased flexibility.

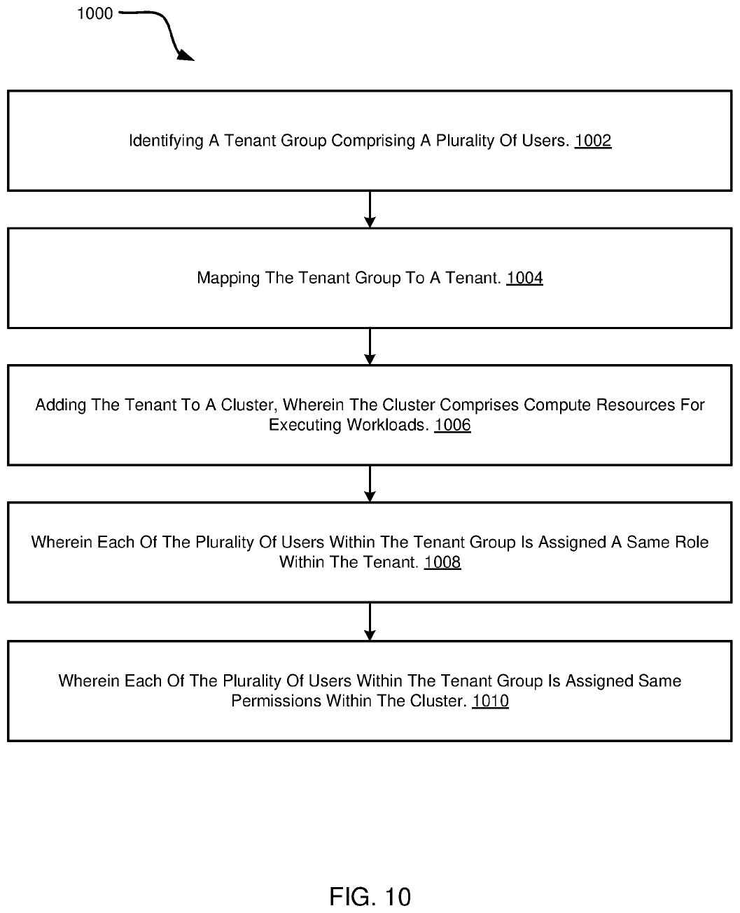

FIG. 10 is a schematic flow chart diagram depicting a method 1000 for mapping a group of users to a tenant within a cluster. The method 1000 begins with identifying at 1002 a tenant group comprising a plurality of users. The tenant group may include a local tenant group 602, or an external tenant group 606 as described herein. The method 1000 includes mapping at 1004 the tenant group to a tenant. The method 1000 includes adding at 1006 the tenant to a cluster, wherein the cluster comprises compute resources for executing workloads. The method 1000 is such that each of the plurality of users within the tenant group is assigned the same role within the tenant (see 1008). The method 1000 is such that each of the plurality of users within the tenant group is assigned the same permissions within the cluster (see 1010).

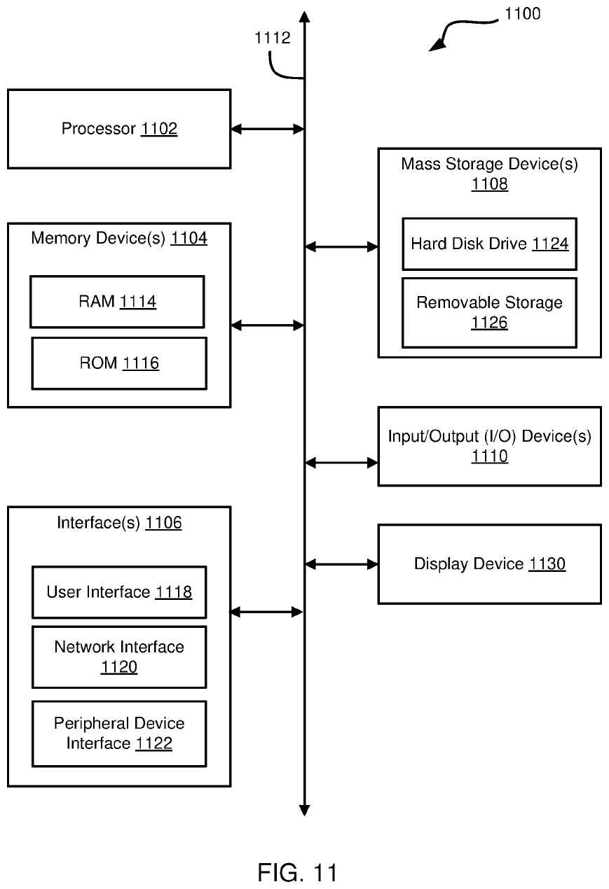

FIG. 11 illustrates a schematic block diagram of an example computing device 1100. The computing device 1100 may be used to perform various procedures, such as those discussed herein. The computing device 1100 can perform various monitoring functions as discussed herein, and can execute one or more application programs, such as the application programs or functionality described herein. The computing device 1100 can be any of a wide variety of computing devices, such as a desktop computer, in-dash computer, vehicle control system, a notebook computer, a server computer, a handheld computer, tablet computer and the like.

The computing device 1100 includes one or more processor(s) 1104, one or more memory device(s) 1104, one or more interface(s) 1106, one or more mass storage device(s) 1108, one or more Input/output (I/O) device(s) 1110, and a display device 1130 all of which are coupled to a bus 1112. Processor(s) 1104 include one or more processors or controllers that execute instructions stored in memory device(s) 1104 and/or mass storage device(s) 1108. Processor(s) 1104 may also include several types of computer-readable media, such as cache memory.

Memory device(s) 1104 include various computer-readable media, such as volatile memory (e.g., random access memory (RAM) 1114) and/or nonvolatile memory (e.g., read-only memory (ROM) 1116). Memory device(s) 1104 may also include rewritable ROM, such as Flash memory.

Mass storage device(s) 1108 include various computer readable media, such as magnetic tapes, magnetic disks, optical disks, solid-state memory (e.g., Flash memory), and so forth. As shown in FIG. 11, a particular mass storage device 1108 is a hard disk drive 1124. Various drives may also be included in mass storage device(s) 1108 to enable reading from and/or writing to the various computer readable media. Mass storage device(s) 1108 include removable media 1126 and/or non-removable media.

I/O device(s) 1110 include various devices that allow data and/or other information to be input to or retrieved from computing device 1100. Example I/O device(s) 1110 include cursor control devices, keyboards, keypads, microphones, monitors or other display devices, speakers, printers, network interface cards, modems, and the like.

Display device 1130 includes any type of device capable of displaying information to one or more users of computing device 1100. Examples of display device 1130 include a monitor, display terminal, video projection device, and the like.

Interface(s) 1106 include various interfaces that allow computing device 1100 to interact with other systems, devices, or computing environments. Example interface(s) 1106 may include any number of different network interfaces 1120, such as interfaces to local area networks (LANs), wide area networks (WANs), wireless networks, and the Internet. Other interface(s) include user interface 1118 and peripheral device interface 1122. The interface(s) 1106 may also include one or more user interface elements 1118. The interface(s) 1106 may also include one or more peripheral interfaces such as interfaces for printers, pointing devices (mice, track pad, or any suitable user interface now known to those of ordinary skill in the field, or later discovered), keyboards, and the like.

Bus 1112 allows processor(s) 1104, memory device(s) 1104, interface(s) 1106, mass storage device(s) 1108, and I/O device(s) 1110 to communicate with one another, as well as other devices or components coupled to bus 1112. Bus 1112 represents one or more of several types of bus structures, such as a system bus, PCI bus, IEEE bus, USB bus, and so forth.

For purposes of illustration, programs and other executable program components are shown herein as discrete blocks, such as block 302 for example, although it is understood that such programs and components may reside at various times in different storage components of computing device 1100 and are executed by processor(s) 1102. Alternatively, the systems and procedures described herein, including programs or other executable program components, can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to preferred features of further embodiments:

Example 1 is a method for organizing users within a network architecture. The method includes identifying a tenant group comprising a plurality of users. The method includes mapping the tenant group to a tenant. The method includes adding the tenant to a cluster, wherein the cluster comprises compute resources for executing workloads. The method is such that each of the plurality of users within the tenant group is assigned a same role within the tenant. The method is such that each of the plurality of users within the tenant group is assigned same permissions within the cluster.

Example 2 is a method as in Example 1, wherein the tenant group is an internal tenant group such that each of the plurality of users is authenticated and managed by the cluster or another compute resource within the network architecture.

Example 3 is a method as in any of Examples 1-2, wherein the tenant group is an external tenant group such that each of the plurality of users is authenticated by an external identity provider.

Example 4 is a method as in any of Examples 1-3, wherein the external identity provider provides authentication services to the cluster.

Example 5 is a method as in any of Examples 1-4, wherein the external identity provider is responsible for authenticating users within an identity provider user group and managing membership of the identity provider user group.

Example 6 is a method as in any of Examples 1-5, wherein identifying the tenant group comprises retrieving a listing of tenant users, and wherein the listing of the tenant users is managed by the cluster; and wherein the method further comprises synchronizing the listing of the tenant users with the identity provider user group managed by the external identity provider.

Example 7 is a method as in any of Examples 1-6, wherein synchronizing the listing of the tenant users within the identity provider user group comprises: cross-checking the listing of the tenant users against the identity provider user group to identify any discrepancies in usernames included in the listing of the tenant users versus usernames included in the identity provider user group; in response to identifying a first username included in the listing of the tenant users that is not included in the identity provider user group, removing the first username from the listing of the tenant users; and in response to identifying a second username included in the identity provider user group that is not included in the listing of the tenant users, adding the second username to the listing of the tenant users.

Example 8 is a method as in any of Examples 1-7, further comprising: adding a user to the tenant group; and in response to adding the user to the tenant group, automatically mapping the user to the tenant and the cluster.

Example 9 is a method as in any of Examples 1-8, further comprising: removing a user from the tenant group; and in response to removing the user from the tenant group, automatically removing any mapping from the user to the tenant.

Example 10 is a method as in any of Examples 1-9, wherein each of the plurality of users within the tenant group is assigned a role comprising super administrator permissions, and wherein the super administrator permissions grant the plurality of users permission to: read and write to all cluster objects; add users to the cluster; register storage repositories to the cluster; share storage repositories associated with the cluster; and export and/or import application backups for applications executed by the cluster.

Example 11 is a method as in any of Examples 1-10, wherein each of the plurality of users within the tenant group is assigned a role comprising tenant administrator permissions, and wherein the tenant administrator permissions grant the plurality of users permission to: read and write to tenant objects; add users to the tenant group mapped to the tenant; register storage repositories to the tenant; share storage repositors associated with the tenant; and export and/or import application backups for applications executed by compute resources of the cluster that are dedicated to the tenant.

Example 12 is a method as in any of Examples 1-11, wherein each of the plurality of users within the tenant group is assigned a role comprising user-only permissions, and wherein the user-only permissions grant the plurality of users' permission to manage one or more applications deployed by or registered to the plurality of users.

Example 13 is a method as in any of Examples 1-12, wherein the tenant is a construct within the network architecture that enables users to be separated into discrete groups based on function or business requirements, and wherein the plurality of users mapped to the tenant are only allowed to access system resources assigned to the tenant.

Example 14 is a method as in any of Examples 1-13, further comprising: authenticating one of the plurality of users to log into the tenant; receiving instructions from the one of the plurality of users to deploy an application; and binding the application to the tenant due to the user being logged into the tenant when the user provided the instructions to deploy the application.

Example 15 is a method as in any of Examples 1-14, wherein the cluster is a component of a containerized workload management system, and wherein the cluster comprises: a control plane node communicating with a plurality of compute nodes; wherein the plurality of compute nodes comprises a physical machine or virtual machine configured to execute objects associated with the cluster.

Example 16 is a method as in any of Examples 1-15, further comprising mapping a plurality of different tenant groups to the tenant, wherein each of the plurality of different tenant groups comprises different users.

Example 17 is a method as in any of Examples 1-16, further comprising: mapping a first tenant group comprising a first plurality of users to the tenant; and mapping a second tenant group comprising a second plurality of users to the tenant; wherein the first tenant group comprises different membership than the second tenant group such that no user included within the first plurality of users is also included within the second plurality of users.

Example 18 is a method as in any of Examples 1-17, wherein the cluster comprises a plurality of tenants, and wherein at least one user is mapped to two or more of the plurality of tenants of the cluster.

Example 19 is a method as in any of Examples 1-18, further comprising: partitioning the cluster into a plurality of different namespaces; and binding the tenant to one or more of the plurality of different namespaces.

Example 20 is a method as in any of Examples 1-19, wherein mapping the tenant group to the tenant comprises scoping each of the plurality of users within the tenant group to at least one of the one or more of the plurality of different namespaces within the cluster.

It will be appreciated that various features disclosed herein provide significant advantages and advancements in the art. The following claims are exemplary of some of those features.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed embodiment.

It is to be understood that any features of the above-described arrangements, examples, and embodiments may be combined in a single embodiment comprising a combination of features taken from any of the disclosed arrangements, examples, and embodiments.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements.

Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Further, where appropriate, functions described herein can be performed in one or more of: hardware, software, firmware, digital components, or analog components. For example, one or more application specific integrated circuits (ASICs) or field programmable gate arrays (FPGAs) can be programmed to carry out one or more of the systems and procedures described herein. Certain terms are used throughout the following description and claims to refer to particular system components. As one skilled in the art will appreciate, components may be referred to by different names. This document does not intend to distinguish between components that differ in name, but not function.

The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method for organizing users within a network architecture, the method comprising:
identifying a tenant group comprising a plurality of users;
mapping the tenant group to a tenant; and
adding the tenant to a cluster, wherein the cluster comprises compute resources for executing workloads; and
wherein each of the plurality of users within the tenant group is assigned a same role within the tenant; and
wherein each of the plurality of users within the tenant group is assigned same permissions within the cluster.

2. The method of claim 1, wherein the tenant group is an internal tenant group such that each of the plurality of users is authenticated and managed by the cluster or another compute resource within the network architecture.

3. The method of claim 1, wherein the tenant group is an external tenant group such that each of the plurality of users is authenticated by an external identity provider.

4. The method of claim 3, wherein the external identity provider provides authentication services to the cluster.

5. The method of claim 4, wherein the external identity provider is responsible for authenticating users within an identity provider user group and managing membership of the identity provider user group.

6. The method of claim 5, wherein identifying the tenant group comprises retrieving a listing of tenant users, and wherein the listing of the tenant users is managed by the cluster; and
wherein the method further comprises synchronizing the listing of the tenant users with the identity provider user group managed by the external identity provider.

7. The method of claim 6, wherein synchronizing the listing of the tenant users within the identity provider user group comprises:
cross-checking the listing of the tenant users against the identity provider user group to identify any discrepancies in usernames included in the listing of the tenant users versus usernames included in the identity provider user group;
in response to identifying a first username included in the listing of the tenant users that is not included in the identity provider user group, removing the first username from the listing of the tenant users; and
in response to identifying a second username included in the identity provider user group that is not included in the listing of the tenant users, adding the second username to the listing of the tenant users.

8. The method of claim 1, further comprising:
adding a user to the tenant group; and
in response to adding the user to the tenant group, automatically mapping the user to the tenant and the cluster.

9. The method of claim 1, further comprising:
removing a user from the tenant group; and
in response to removing the user from the tenant group, automatically removing any mapping from the user to the tenant.

10. The method of claim 1, wherein each of the plurality of users within the tenant group is assigned a role comprising super administrator permissions, and wherein the super administrator permissions grant the plurality of users permission to:
read and write to all cluster objects;
add users to the cluster;
register storage repositories to the cluster;
share storage repositories associated with the cluster; and
export and/or import application backups for applications executed by the cluster.

11. The method of claim 1, wherein each of the plurality of users within the tenant group is assigned a role comprising tenant administrator permissions, and wherein the tenant administrator permissions grant the plurality of users permission to:
read and write to tenant objects;
add users to the tenant group mapped to the tenant;
register storage repositories to the tenant;
share storage repositors associated with the tenant; and
export and/or import application backups for applications executed by compute resources of the cluster that are dedicated to the tenant.

12. The method of claim 1, wherein each of the plurality of users within the tenant group is assigned a role comprising user-only permissions, and wherein the user-only permissions grant the plurality of users permission to manage one or more applications deployed by or registered to the plurality of users.

13. The method of claim 1, wherein the tenant is a construct within the network architecture that enables users to be separated into discrete groups based on function or business requirements, and wherein the plurality of users mapped to the tenant are only allowed to access system resources assigned to the tenant.

14. The method of claim 1, further comprising:
authenticating one of the plurality of users to log into the tenant;
receiving instructions from the one of the plurality of users to deploy an application; and
binding the application to the tenant due to the user being logged into the tenant when the user provided the instructions to deploy the application.

15. The method of claim 1, wherein the cluster is a component of a containerized workload management system, and wherein the cluster comprises:
a control plane node communicating with a plurality of compute nodes;
wherein the plurality of compute nodes comprises a physical machine or virtual machine configured to execute objects associated with the cluster.

16. The method of claim 1, further comprising mapping a plurality of different tenant groups to the tenant, wherein each of the plurality of different tenant groups comprises different users.

17. The method of claim 1, further comprising:
mapping a first tenant group comprising a first plurality of users to the tenant; and
mapping a second tenant group comprising a second plurality of users to the tenant;
wherein the first tenant group comprises different membership than the second tenant group such that no user included within the first plurality of users is also included within the second plurality of users.

18. The method of claim 1, wherein the cluster comprises a plurality of tenants, and wherein at least one user is mapped to two or more of the plurality of tenants of the cluster.

19. The method of claim 1, further comprising:
partitioning the cluster into a plurality of different namespaces; and
binding the tenant to one or more of the plurality of different namespaces.

20. The method of claim 19, wherein mapping the tenant group to the tenant comprises scoping each of the plurality of users within the tenant group to at least one of the one or more of the plurality of different namespaces within the cluster.
